(19) United States
(12) Patent Application Publication
(10) Pub. No.: US 2009/0106939 A1
(43) Pub. Date: Apr. 30, 2009

(54) TORSION ADJUSTMENT STRUCTURE, MEMBER, AND METHOD FOR HINGE DEVICE

(76) Inventor: Jui-Hung CHANG, Sinjhuang City (TW)

Correspondence Address: SINORICA, LLC, 528 FALLSGROVE DRIVE, ROCKVILLE, MD, 20850, US

(21) Appl. No.: 12/243,107

(22) Filed: Oct. 1, 2008

(30) Foreign Application Priority Data
Oct. 26, 2007 (TW) 096140582

(51) Int. Cl. E05D 11/08; E05D 3/02

(52) U.S. Cl. 16/342

(57) ABSTRACT

A torsion adjustment structure, member, and method for hinge device uses the hole diameters of a plurality of enclosing ends of an enclosing part as the torsion adjustment means, in which the interferences between the external pivoting diameter of the pivotal axle and the hole diameters of the plurality of the enclosing ends are different, such that the total torsion can be easily adjusted and the product's applicability can be expanded.

### FIELD OF THE INVENTION

The present invention relates to a torsion adjustment structure, member, and method for hinge device and in particular to a torsion adjustment structure, member, and method of torsion adjustment suitable for an enclosed hinge device.

### BACKGROUND OF THE INVENTION

“Rotating Shaft Structure with Automatic Locking Mechanism,” developed by the present inventor, is disclosed in the ROC Patent No. M296586 on Aug. 21, 2006 (corresponding to the PRC Patent No. 200620001995.4), as shown in FIG. 17. The invention mainly involves inserting the shaft 101 of an axial member 10 into, in the order of, a friction disc 30, a plate connecting part 40, a cam member 50, an elastic body 60, and securingly fixed onto the main frame 20, wherein the cam member 50 comprises a fastening part 501 and a sliding part 502, and when the axial member 10 rotates, the wedge slot 502a of the sliding part 502 is driven to slide and engage into the wedge block 501a of the fastening part 501, achieving the auto-locking function.

However, the recent design of hinge device has varied greatly to meet different demands in torque. Therefore, to expand the product's applicability and resolve the issue of materials preparation, there is still room for improvement in the design of hinge devices.

### SUMMARY OF THE INVENTION

The main object of the present invention is to provide a torsion adjustment structure, member, and method for hinge device, employing the hole diameters of a plurality of enclosing ends of an enclosing part as the torsion adjustment means, in which the interferences between the external pivoting diameter of the pivotal axle and the hole diameters of the plurality of the enclosing ends are different to achieve the purpose of torsion adjustment.

The major improvement of the present invention lies in the fact that the plurality of the enclosing part has the function of additive torsion adjustment and the easy adjustment of total torsion so as to enhance the product's applicability and resolve the issue of material preparation; furthermore, the enclosing end can also strengthen the structural stability and thus reduce the rotational shaking of the pivotal axle.

A torsion adjustment method for hinge device according to one preferred embodiment of the present invention comprises at least the following steps:

an enclosing part is formed to have a plurality of enclosing ends;

the plurality of the enclosing ends are formed to have openings of the same direction and point to the inner side, and the hole diameters of the plurality of the enclosing ends are formed to be different;

the pivotal axle is pivoted onto the plurality of the enclosing ends so as to enable the external pivoting diameter of the pivotal axle having different interferences with the hole diameters;

with the aforementioned steps, the pivotal axle may generate different frictional torsions with the plurality of the enclosing ends.

A torsion adjustment method for hinge device according to another preferred embodiment of the present invention comprises at least the following steps:

an enclosing part is formed to have a plurality of enclosing ends;

the plurality of the enclosing ends are formed to have openings of the opposite directions and the hole diameters of the plurality of the enclosing ends are formed to be different;

the pivotal axle is pivoted onto the plurality of the enclosing ends so as to enable the external pivoting diameter of the pivotal axle having different interferences with the hole diameters;

with the aforementioned steps, the pivotal axle may generate different frictional torsions with the plurality of the enclosing ends.

A torsion adjustment structure for hinge device according to a further preferred embodiment of the present invention comprises:

an enclosing part having a first enclosing end and a second enclosing end;

an arresting part securingly fixed onto one side of the enclosing part;

a pivotal axle having a first axle segment pivoted onto the first and second enclosing ends to have two frictional torsions, between which a difference can be found, and a second axle segment is pivoted onto the arresting part and inserted through, in the order of, the locking retainer, a locking rotator, and elastic parts with the end of the second axle segment being securingly retained with a nut.

### BRIEF DESCRIPTION OF THE DRAWINGS

The present invention can be more fully understood by reference to the following description and accompanying drawings, in which:

FIG. 1 is the perspective view of a torsion adjustment member of the present invention;

FIG. 2 is the cross-sectional view taken through the A-A line of the enclosing part in FIG. 1;

FIG. 3 is schematic view of the preferred embodiment of a torsion adjustment member of the present invention;

FIG. 4 is an alternative of the preferred embodiment of FIG. 1;

FIG. 5 is a further alternative of the preferred embodiment of FIG. 1;

FIG. 6 is the perspective view of the second embodiment of the torsion adjustment member;

FIG. 7 is the cross-sectional view taken through the B-B line of the enclosing part in FIG. 6;

FIG. 8 is a schematic view of the preferred embodiment of the torsion adjustment structure in FIG. 6;

FIG. 9 is an alternative of the preferred embodiment of the enclosing part of the present invention;

FIG. 10 is the schematic view of the exploded perspective view of FIG. 3;

FIG. 11 is an exploded perspective view of FIG. 10 from another view angle;

FIG. 12 is the cross-sectional view taken through the C-C line in FIG. 3;

FIG. 13 is the cross-sectional view taken through the D-D line in FIG. 3;

FIGS. 14 and 15 are the schemation of preferred embodiments of the pivotal axle connected with a fixed seat of the present invention;

FIG. 16 is a schematic view for the exploded perspective view of FIG. 8; and

FIG. 17 is an exploded perspective view of a prior art.

### DETAILED DESCRIPTION OF THE INVENTION

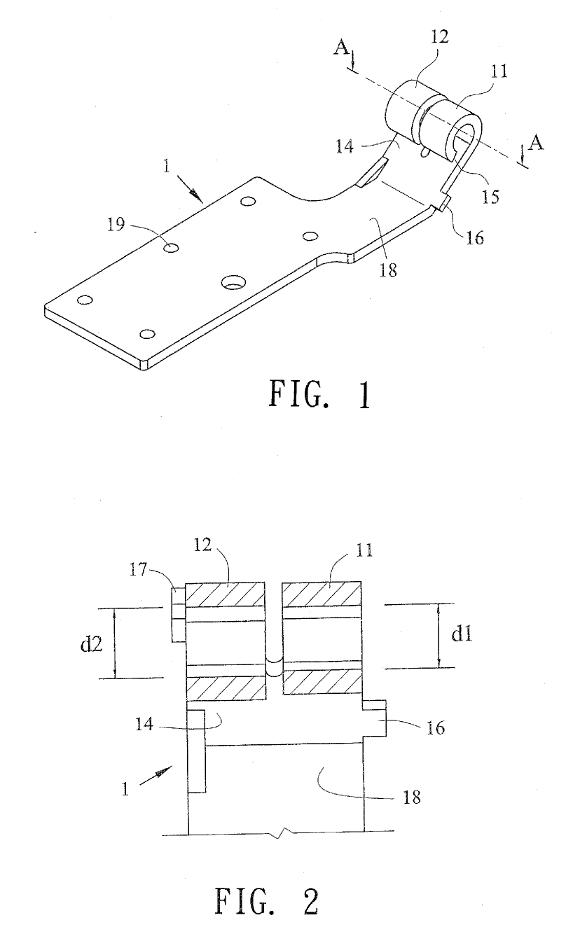

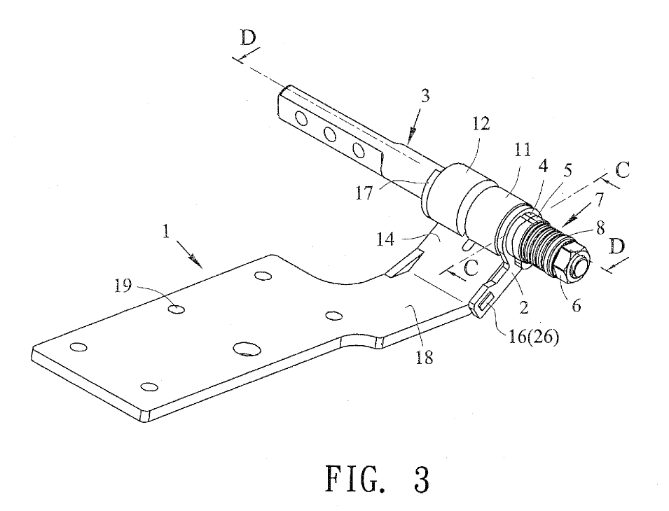

With reference to FIGS. 1 to 3, one preferred embodiment of the torque adjustment method for hinge device according to the present invention comprises the following steps:

an enclosing part 1 is formed to have a first enclosing end 11 and a second enclosing end 12;

the first and second enclosing ends 11, 12 are formed to have openings 15 of the same direction and point to an inner face 14, and the hole diameters, d1 and d2, of the first and second enclosing ends 11, 12 are formed to be different;

a pivotal axle 3 is pivoted onto the first and second enclosing ends 11, 12 so as to enable the external pivoting diameter of the pivotal axle 3 having different interferences with the hole diameters d1 and d2;

in other words, the pivotal axle 3 may generate different frictional torsions with the first and second enclosing ends 11, 12, respectively; consequently, there is a difference in the frictional torsion generated between the pivotal axle 3 with the first and second enclosing ends 11, 12 such that the aim of torsion adjustment can be achieved and the enclosing part 1 can also enhance the structural stability and thus reduce the rotational shaking of the pivotal axle 3.

For example, when the pivotal axle 3 rotates toward the inner face 14 and the frictional torsions generated between the pivotal axle 3 pivoted with the first enclosing end 11 and the second enclosing end 12 are 5 kg/cm and 4 kg/cm, respectively, the additive frictional torsion is 9 kg/cm; when the pivotal axle 3 rotates toward the external side, and the frictional torsion generated between the pivotal axle 3 pivoted with the first enclosing end 11 is 3 kg/cm due to the effect of the opening 15 and that with the second enclosing end 12 is 2 kg/cm, the additive frictional torsion is 5 kg/cm. Consequently, the “positive difference” of the total frictional torsion may reach about 4 kg/cm (9 kg/cm−5 kg/cm=4 kg/cm). However, before the addition is made, the “positive difference” of the frictional torsion generated at the first enclosing end 11 is about 2 kg/cm (5 kg/cm−3 kg/cm=2 kg/cm) and the “positive difference” of the frictional torsion generated at the second enclosing end 12 is about 2 kg/cm (4 kg/cm−2 kg/cm=2 kg/cm). The preferred embodiment of the present invention, however, may effectively adjust the “positive difference” of the frictional torsion, reaching as high as 4 kg/cm (9 kg/cm−5 kg/cm=4 kg/cm), which is an advantage of the torsion adjustment of the accumulating frictional torsion.

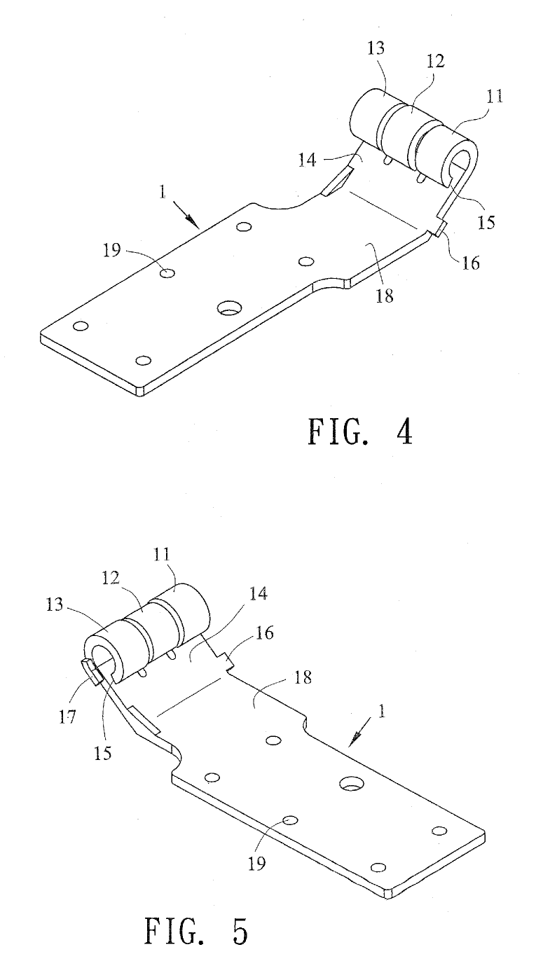

With reference to FIG. 4, the enclosing part 1 may also comprise a first enclosing end 11, a second enclosing end 12, and a third enclosing end 13, whose openings 15 have the same direction and point to the inner side, the hole diameters of the first and third enclosing ends 11, 13 are smaller than that of the second enclosing end 12; in other words, after the pivotal axle 3 is being pivoted, it generates a first frictional torsion, a second frictional torsion, and a third frictional torsion, wherein the first and third frictional torsions are larger than the second frictional torsion.

With reference to FIG. 5, the enclosing part 1 may also comprise a first enclosing end 11, a second enclosing end 12, and a third enclosing end 13, whose openings 15 have the same direction and point to the inner side, and the hole diameters of the first and third enclosing ends 11, 13 are larger than that of the second enclosing end 12; in other words, after the pivotal axle 3 is being pivoted, it generates a first frictional torsion, a second frictional torsion, and a third frictional torsion, wherein the first and third frictional torsions are smaller than the second frictional torsion.

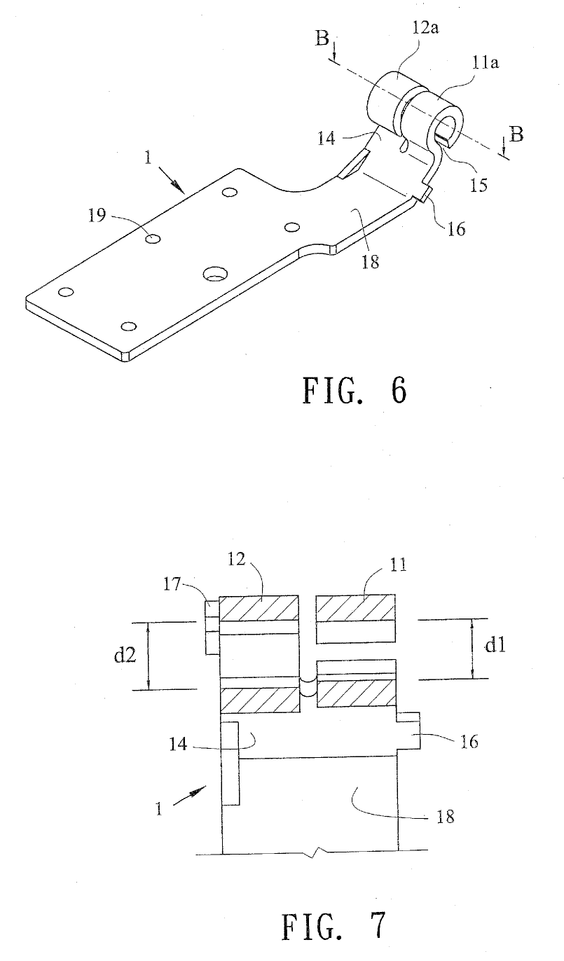

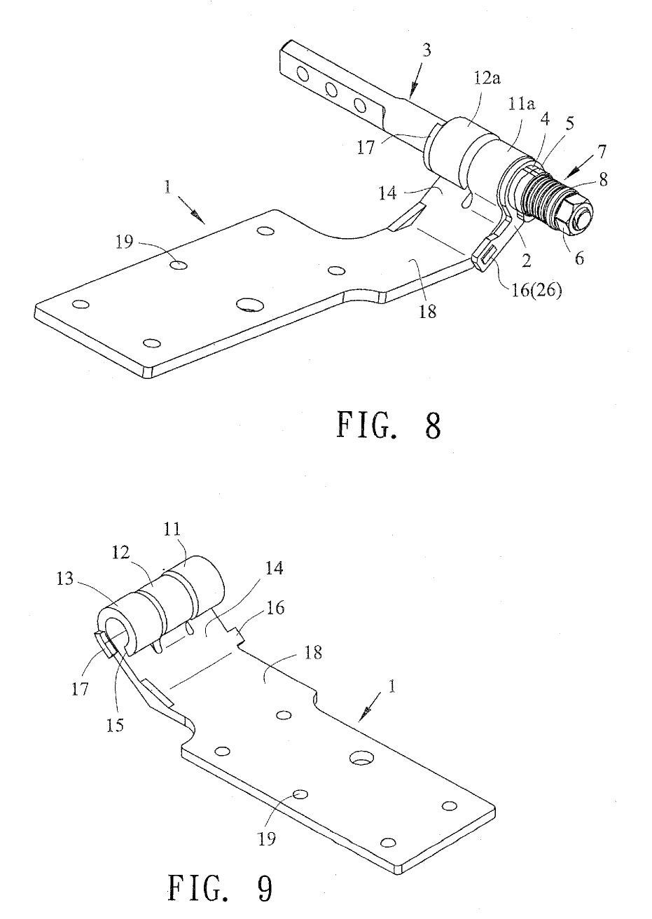

With reference to FIGS. 6 to 8, the second embodiment of the torque adjustment method for hinge device according to the present invention comprises the following steps:

an enclosing part 1 is formed to have a first enclosing end 11a and a second enclosing end 12a;

the first and second enclosing ends 11a, 12a are formed to have openings 15 of the opposite direction, and the hole diameters, d1 and d2, of the first and second enclosing ends 11a, 12a are formed to be different; a pivotal axle 3 is pivoted onto the first and second enclosing ends 11a, 12a so as to enable the external pivoting diameter of the pivotal axle 3 having different interferences with the hole diameters d1 and d2;

in other words, the pivotal axle 3 may generate different frictional torsions with the first and second enclosing ends 11a, 12a, respectively; consequently, there is a difference in the frictional torsion generated between the pivotal axle 3 with the first and second enclosing ends 11a, 12a such that the aim of torsion adjustment can be achieved and the enclosing part 1 can enhance the structural stability and thus reduce the rotational shaking of the pivotal axle 3.

For example, when the pivotal axle 3 rotates toward the inner face 14 and the frictional torsion generated between the pivotal axle 3 pivoted with the first enclosing end 11a is 3 kg/cm and that with the second enclosing end 12a is 6 kg/cm, the additive frictional torsion is 9 kg/cm; when the pivotal axle 3 rotates toward the external side, and the frictional torsion generated between the pivotal axle 3 pivoted with the first enclosing end 11a is 5 kg/cm due to the effect of the opening 15 and that with the second enclosing end 12a is 2 kg/cm, the additive frictional torsion is 7 kg/cm. Consequently, the “positive difference” of the total frictional torsion may maintain at 2 kg/cm (9 kg/cm−7 kg/cm=2 kg/cm) even if the first enclosing end 11 and the second enclosing end 12 have opposite openings 15 without being completely cancelled out to be zero.

With reference to FIG. 9, the enclosing part 1 may also comprise a first enclosing end 11, a second enclosing end 12, and a third enclosing end 13 with the first and third openings 15 having the same direction and pointing to the inner side, and the opening 15 of the second enclosing end 12 pointing to the opposite direction, and the hole diameters of the first and third enclosing ends 11, 13 are larger than that of the second enclosing end 12; in other words, after the pivotal axle 3 is being pivoted, it generates a first frictional torsion, a second frictional torsion, and a third frictional torsion, wherein the first and third frictional torsions are smaller than the second frictional torsion. Furthermore, if the hole diameters of the first and third enclosing ends 11, 13 are smaller than that of the second enclosing end 12, the first and third frictional torsions are larger than the second frictional torsion, which may also be another embodiment.

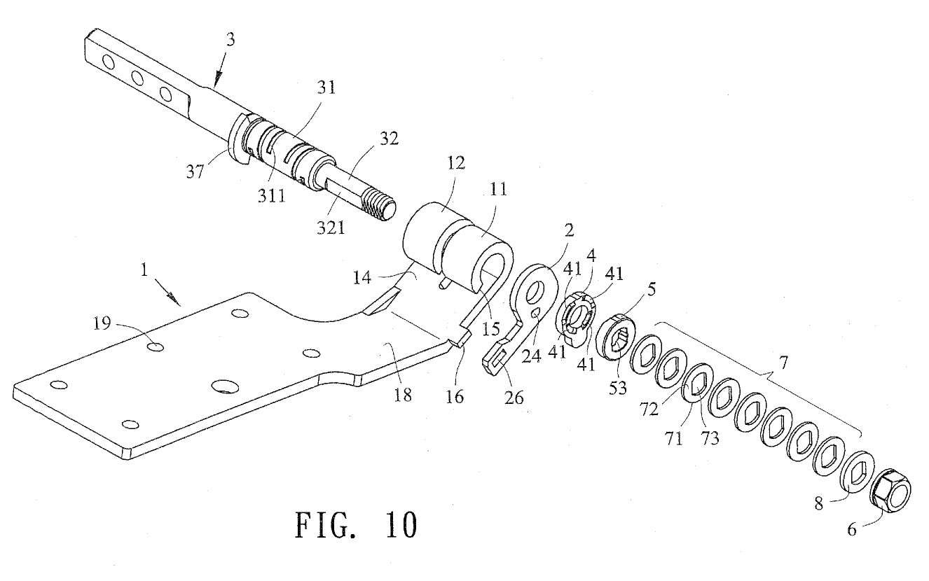

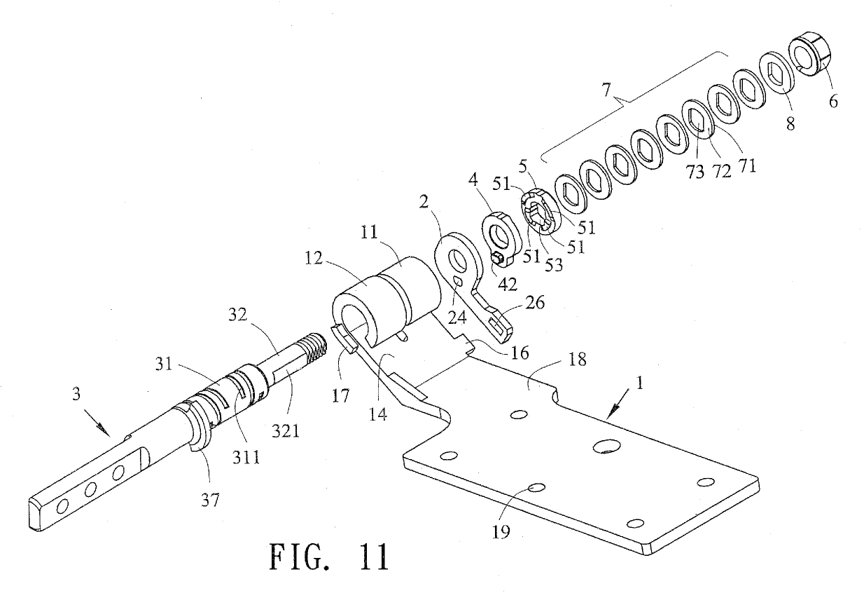

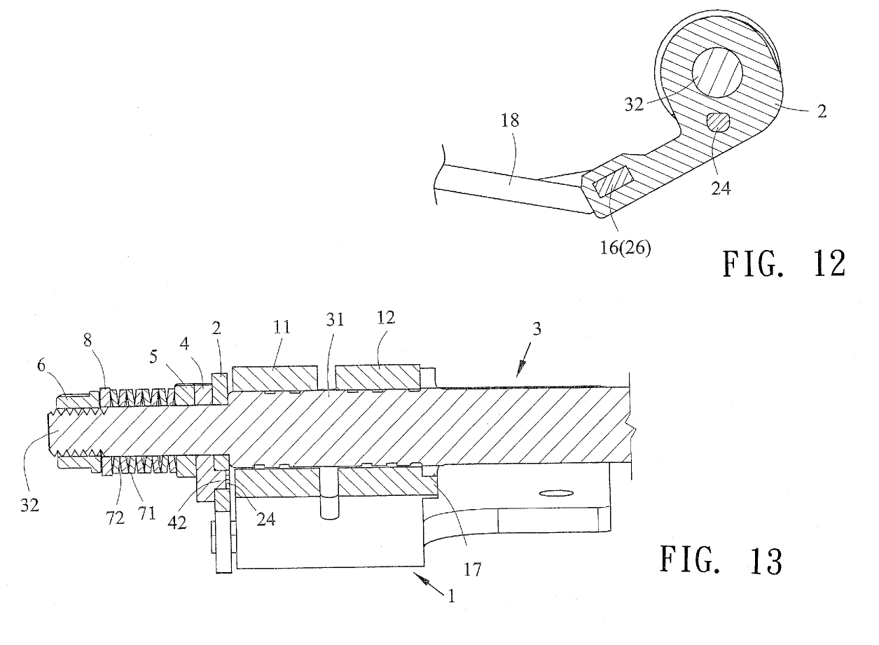

With reference to FIGS. 10 to 15, the torsion adjustment structure for hinge device comprises:

an enclosing part 1 having a first enclosing end 11 and a second enclosing end 12;

an arresting part 2 securingly fixed onto one side of the enclosing part 1 (for example, the enclosing part 1 is on its one side disposed with a protruded block 16 and a notch 26 is disposed on the arresting part 2, wherein the protruded block 16 may be embeddingly fixed onto the notch 26 to join together the enclosing part 1 and the arresting part 2);

a pivotal axle 3 having a first axle segment 31 pivoted onto the first and second enclosing ends 11, 12, to have two frictional torsions, between which a difference can be found, and a second axle segment 32 pivoted onto the arresting part 2 and inserted through, in the order of, the locking retainer 4, a locking rotator 5, and an elastic part 7 with the end of the second axle segment 32 being securingly retained with a nut 6.

The openings 15 of the first enclosing end 11 and the second enclosing end 12 are in the same direction and point to the inner face 14. The locking retainer 4 has a positioning slot 41 and is securingly fixed onto the arresting part 2. The locking rotator 5 has a positioning block 51 and is jointly rotatable with the second axle segment 32 of the pivotal axle 3. When the locking rotator 5 is in the locking position, the positioning block 51 is positioned into the positioning slot 41. The locking retainer 4 is disposed with a pin 42 and the arresting part 2 is correspondingly formed to have a pin hole 24 to securingly fix the locking retainer 4 onto the arresting part 2.

The other side of the enclosing part 1 is disposed with a stopping portion 17 and the first axle segment 31 of the pivotal axle 3 is disposed with a positioning portion 37. When the pivotal axle 3 is being rotated, the positioning portion 37 of the pivotal axle 3 may be abutted against the stopping portion 17 so as to limit the rotation angle of the pivotal axle 3. The elastic part 7 is a plurality of spring discs 71 or springs (not shown), and the plurality of the spring discs 71 are formed to have arc faces 72 and alternately inserted in opposite faces onto the end of the second axle segment 32. The second axle segment 32 of the pivotal axle 3 is formed to have at least a flat face 321, and the locking rotator 5 and the plurality of the spring discs 71 are correspondingly formed to have fastening holes 53 and 73, respectively, so as to be inserted onto the second axle segment 32. A gasket 8 is disposed between the nut 6 and the elastic part 7. The first axle segment 31 of the pivotal axle 3 may be formed to have oil grooves 311.

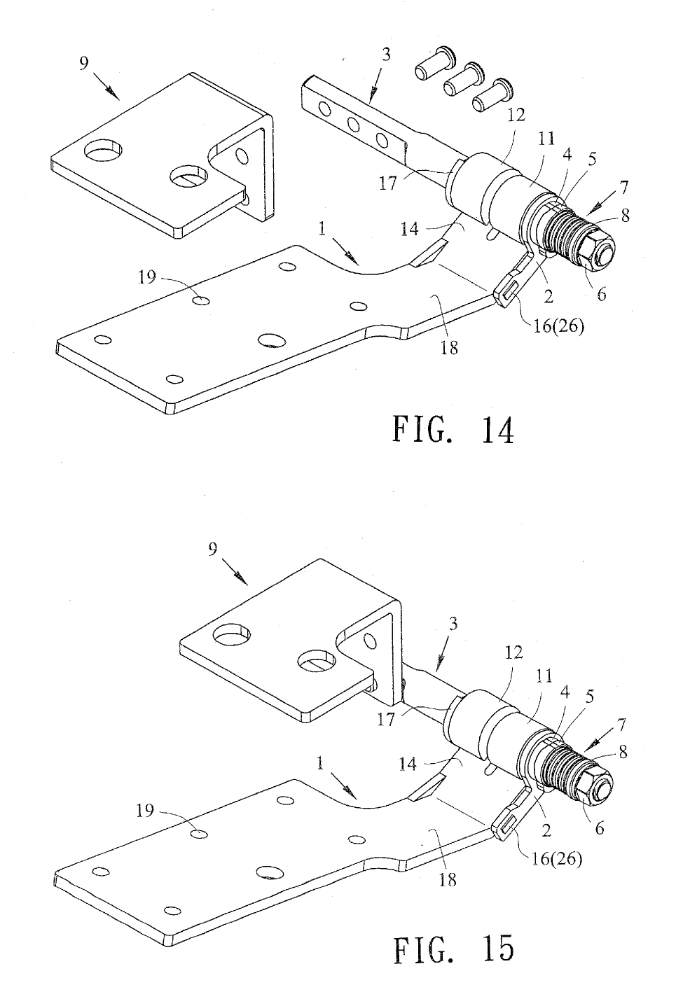

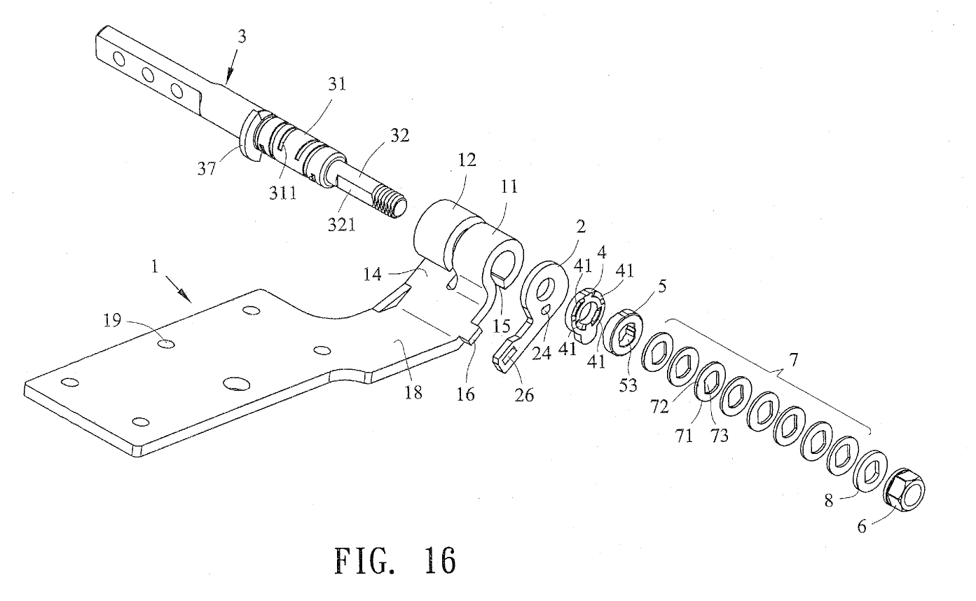

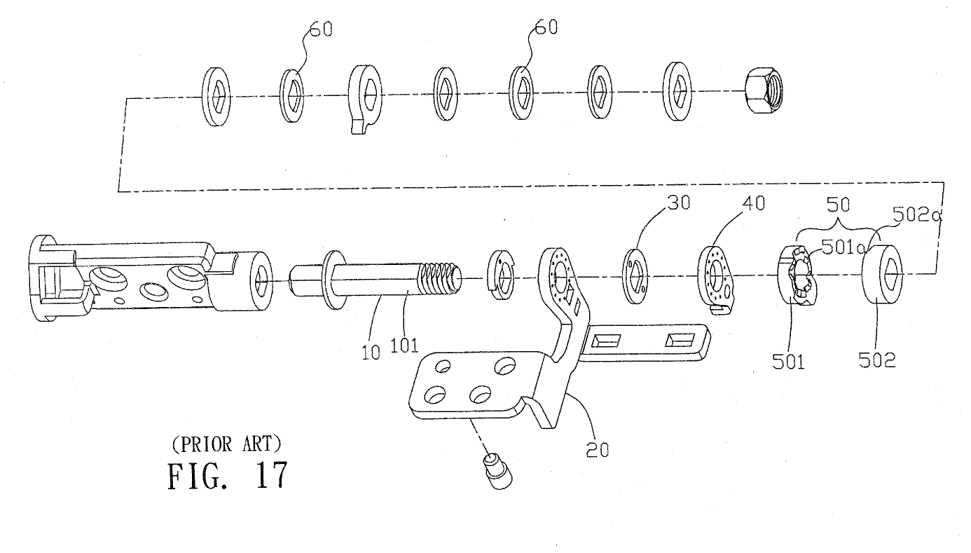

With reference to FIGS. 14 and 15, the extending end 18 of the enclosing part 1 is formed to have a positioning hole 19 and the pivotal axle 3 may be connected with a fixed seat 9. With reference to FIG. 16, the torsion adjustment structure according to the present invention may be further re-designed such that the openings 15 of the first enclosing end 11 and the second enclosing end 12 point to opposite direction and the opening 15 of the first enclosing end 11 points to the inner face 14.

While the invention has been described with reference to the a preferred embodiment thereof, it is to be understood that modifications or variations may be easily made without departing from the spirit of this invention, which is defined by the appended claims.

What is claimed is:

1. A torsion adjustment structure for hinge device, comprising:
an enclosing part having a first enclosing end and a second enclosing end;
an arresting part securingly fixed onto one side of the enclosing part;
a pivotal axle having a first axle segment pivoted onto the first and second enclosing ends to have two frictional torsions, between which a difference can be found;
wherein a second axle segment is pivoted onto the arresting part and inserted through, in the order of, the locking retainer, a locking rotator, and an elastic part with the end of the second axle segment being securingly retained with a nut.

2. The torsion adjustment structure for hinge device of claim 1, wherein the openings of the first enclosing end and the second enclosing end have the same direction and point to the inner face.

3. The torsion adjustment structure for hinge device of claim 1, wherein the openings of the first enclosing end and the second enclosing end have opposite directions and the opening of the first enclosing end points to the inner face.

4. The torsion adjustment structure for hinge device of claim 1, wherein the locking retainer has a positioning slot and is securingly fixed onto the arresting part; the locking rotator has a positioning block and is jointly rotatable with the second axle segment of the pivotal axle; when the locking rotator is in the locking position, the positioning block is positioned into the positioning slot.

5. The torsion adjustment structure for hinge device of claim 1, wherein the locking retainer is disposed with a pin and the arresting part is correspondingly formed to have a pin hole to securingly fix the locking retainer onto the arresting part

6. The torsion adjustment structure for hinge device of claim 1, wherein the other side of the enclosing part s disposed with a stopping portion and the first axle segment of the pivotal axle is disposed with a positioning portion; when the pivotal axle is being rotated, the positioning portion of the pivotal axle may be abutted against the stopping portion so as to limit the rotation angle of the pivotal axle.

7. The torsion adjustment structure for hinge device of claim 1, wherein the elastic part is a plurality of spring discs or springs, and the plurality of the spring discs are formed to have arc faces and alternately inserted in opposite faces onto the end of the second axle segment; the second axle segment of the pivotal axle is formed to have at least a flat face, and the locking rotator and the plurality of the spring discs are correspondingly formed to have fastening holes, respectively, so as to be inserted onto the second axle segment.

8. The torsion adjustment structure for hinge device of claim 1, wherein a gasket is disposed between the nut and the elastic part.

9. The torsion adjustment structure for hinge device of claim 1, wherein the first axle segment of the pivotal axle may be formed to have oil grooves.

10. The torsion adjustment structure for hinge device of claim 1, wherein the extending end of the enclosing part is formed to have a positioning hole and the pivotal axle may be connected with a fixed seat.

11. A torsion adjustment member for hinge device is an enclosing part characterized by comprising:
a first enclosing end, a second enclosing end, and a third enclosing end for the pivoting of the pivotal axle and generate a first frictional torsion, a second frictional torsion, and a third frictional torsion, respectively;
wherein the openings of the first, second, and third enclosing ends have the same direction and point to the inner side, and the first and third frictional torsions are larger than the second frictional torsion.

12. The torsion adjustment member for hinge device of claim 11, wherein one side of the enclosing part is disposed with a protruded block or notch and the other side of the enclosing part is disposed with a stopping portion; the extending end of the enclosing part is formed to have a positioning hole.

13. A torsion adjustment member for hinge device is an enclosing part characterized by comprising:
a first enclosing end, a second enclosing end, and a third enclosing end to pivot the pivotal axle and generate a first frictional torsion, a second frictional torsion, and a third frictional torsion, respectively;
wherein the openings of the first, second, and third enclosing end have the same direction and point to the inner side, and the first and third frictional torsions are smaller than the second frictional torsion.

14. The torsion adjustment member for hinge device of claim 13, wherein one side of the enclosing part is disposed with a protruded block or notch and the other side of the enclosing part is disposed with a stopping portion; the extending end of the enclosing part is formed to have a positioning hole.

15. A torsion adjustment member for hinge device is an enclosing part characterized by comprising:
a first enclosing end, a second enclosing end, and a third enclosing end to pivot the pivotal axle and generate a first frictional torsion, a second frictional torsion, and a third frictional torsion, respectively;
wherein the openings of the first and third enclosing ends have the same direction and point to the inner side, and the opening of the second enclosing end points to the outer side; the first and third frictional torsions are smaller than the second frictional torsion.

16. The torsion adjustment member for hinge device of claim 15, wherein one side of the enclosing part is disposed with a protruded block or notch and the other side of the enclosing part is disposed with a stopping portion; the extending end of the enclosing part is formed to have a positioning hole.

17. A torsion adjustment member for hinge device is an enclosing part characterized by comprising:
a first enclosing end, a second enclosing end, and a third enclosing end to pivot the pivotal axle and generate a first frictional torsion, a second frictional torsion, and a third frictional torsion, respectively;
wherein the openings of the first and third enclosing ends have the same direction and point to the inner side and the opening of the second enclosing end points to the outer side, and the first and third frictional torsions are larger than the second frictional torsion.

18. The torsion adjustment member for hinge device of claim 17, wherein one side of the enclosing part is disposed with a protruded block or notch and the other side of the enclosing part is disposed with a stopping portion; the extending end of the enclosing part is formed to have a positioning hole.

19. A torsion adjustment method for hinge device comprises at least the following steps:
an enclosing part is formed to have a plurality of enclosing ends;
the plurality of the enclosing ends are formed to have openings of the same direction and point to the inner side and the hole diameters of the plurality of the enclosing ends are formed to be different;
a pivotal axle is pivoted onto the plurality of the enclosing ends so as to enable the external pivoting diameter of the pivotal axle having different interferences with the hole diameters;
with the aforementioned steps, the pivotal axle may generate different frictional torsions with the plurality of the enclosing ends.

20. A torsion adjustment method for hinge device comprises at least the following steps:
an enclosing part is formed to have a plurality of enclosing ends;
the plurality of the enclosing ends are formed to have openings of the opposite directions and the hole diameters of the plurality of the enclosing ends are formed to be different;
a pivotal axle is pivoted onto the plurality of the enclosing ends so as to enable the external pivoting diameter of the pivotal axle having different interferences with the hole diameters;
with the aforementioned steps, the pivotal axle may generate different frictional torsions with the plurality of the enclosing ends.
